(19) United States
(12) Patent Application Publication
(10) Pub. No.: US 2009/0006419 A1
(43) Pub. Date: Jan. 1, 2009

(54) System and Method for Personalized Health Information Delivery

(76) Inventors: Eric Savitsky, Malibu, CA (US); Swaminatha Mahadevan, Palo Alto, CA (US)

Correspondence Address: WHYTE HIRSCHBOECK DUDEK S.C.;INTELLECTUAL PROPERTY DEPARTMENT, 33 East Main Street, Suite 300, Madison, WI, 53703-4655, US

(21) Appl. No.: 12/092,960

(22) PCT Filed: Nov. 7, 2006
(86) PCT No.: PCT/US06/60619

§ 371 Date: Sep. 9, 2008

Related U.S. Application Data
(60) Provisional application No. 60/734,249, filed on Nov. 7, 2005.

(51) Int. Cl. G06F 17/30

(52) U.S. Cl. 707/10; 707/100; 707/E17.009; 707/E17.032

(57) ABSTRACT

Embodiments of the present invention provide a system and method for providing mobile handheld (e.g., mobile phones, handheld computers) device users the ability to access personalized health information from a variety of locations. A computerized mobile handheld device, customized software programming, and broadband transmission of information using the Internet and wireless networks is provided. System users are provided access to highly relevant healthcare topics for their personal review with minimal searching effort. The user iteratively responds to a series of prompts by clicking, using voice recognition, or telemetric data input technology to register his or her response. The user's responses are linked to a series of health information topics, which appear on the user interface. This series of healthcare topics provide the user information on the respective health issue. The series of healthcare topics are rearranged in order of most relevant to least relevant based on the user's data inputs.

This application claims the benefit of U.S. Provisional Patent Application No. 60/734,249, entitled “System and Method for Personalized Health Information Delivery over Broadband Networks” filed on Nov. 7, 2005, which is hereby incorporated by reference herein.

### FIELD OF THE INVENTION

The present invention relates to health knowledge systems. In particular, the present invention relates to delivery systems for health knowledge.

### BACKGROUND OF THE INVENTION

Previous methods of obtaining medical or personal health information often include traditional media, which include books, magazines, and medical journals by example. The advent of the Internet and digital technology has provided new portals for consumer health information. It is often projected that more than 80 percent of Internet users have performed electronic searches for medical information. However, many previous methods of providing specific health information are often inefficient and impractical for users positioned away from their home or office-based computers.

By example, typing a term into a commercial Internet-based search engine will often generate hundreds to thousands of search results. Individuals must then attempt to further refine their search with the hopes of uncovering the most relevant information. This often involves the download and review of multiple documents which can be irrelevant and detract from the user's search, thereby making the process more arduous and inefficient than necessary. This iterative process is very difficult and not feasible when using smaller mobile handheld devices (e.g., mobile phones). The small screen size, small keyboard, and latency issues surrounding mobile handheld devices limit the browsing and viewing functionality of such devices. More importantly, many users have a complaint (e.g., chest pain) and want to know more about the precise possible causes of their malady. Current search methods using Internet-based search engines often provide links to many specific causes (e.g., costochondritis) of chest pain. The average user would need to sort through all the possible illnesses that cause chest pain provided by the search engine. Users would then need to review all the amassed information and discern what literature was most applicable to their condition.

Internet searching can provide term weighting as well as other strategies for ranking search results. By example, one previous method for search weighting includes link analysis, which considers the nature of each hit in terms of its associations with other search hits. The search hit is identified as a potential authority, based upon other hits pointing to it, or a potential hub, based upon the number of pages it points to. A well known search engine, Google, has used link analysis for web page search results ranking.

Other than assisting in the diagnosis of very specific medical conditions over a narrow spectrum of disorders computerized diagnostic engines have been largely ineffective. Many medical variables (e.g., type and degree of pain) remain difficult to reliably quantify and are very subjective in nature. This variability limits the utility of computerized medical diagnostic engines, which rely on objective data for generating results.

There are over 120 million emergency room (ER) visits per year in the United States. This number increased by 26 percent from 1993 to 2003, while the number of ER's decreased by 12 percent over the same period. Nearly 45 million Americans are uninsured and total out-of-pocket spending on health care rose $13.7 billion, to $230 billion in 2003. Employee spending for health insurance coverage has increased 126 percent between 2000 and 2004. Concurrently, traditional media conglomerates are hoping to maintain advertising revenues by gaining broader access to consumers through internet and mobile wireless outlets. Internet advertising revenues rose by 33 percent last year to 9.6 billion dollars. A recent Pew internet study documented over 80 percent of internet users have searched for independent information regarding health topics, while 66 percent sought information regarding a specific medical problem.

It would be advantageous to provide a healthcare information delivery system that is a solution to the progressively expensive healthcare system. It would be advantageous for a healthcare delivery system to provide mobile handheld device users the ability to immediately access personalized health information in a wide variety of locations. It would be further advantageous to provide remote users a customized list of relevant health-related topics. This solves the problem of users with limited healthcare background attempting to discern which search results obtained from alternative sources (e.g., web portals, journals, etc.,) are most relevant to their current health concern. It would be further advantageous to provide a system that provides a solution to the latency and browser limitations of searching Internet-based databases using a mobile device. It would be advantageous if this system would allow users immediate access to relevant health-related information on the topic of the user's interest in a widely accessible and easy to use fashion.

Additional features of the present invention will become apparent to those skilled in the art upon consideration of the following detailed description of preferred embodiments exemplifying the best mode of carrying out the invention as presently perceived.

### SUMMARY OF THE INVENTION

Accordingly, one aspect of the present invention is a mobile computing device. The mobile computing device includes a user interface, a central processing unit (CPU) for performing computer executable instructions, a wireless interface for data export and retrieval, and a memory storage device. The memory storage device stores computer executable instructions that when executed by the CPU cause the CPU to perform a process for ranking a list of healthcare related information topics by relevancy based upon responses to a query set. The query set is specific to a healthcare related subject. The healthcare related information segment is associated with the topic, and the healthcare information segment is a multimedia presentation executed by the mobile computing device.

Another aspect of the invention is a healthcare information delivery system including a mobile computing device is provided. The healthcare information system includes a network memory storage device for storing multimedia segments, a computer network connected to the network memory storage device, and a wireless access point. The wireless access point connects the mobile device to the computer network. The multimedia segments are requested from the network memory storage device by the mobile computing device, and the requested multimedia segments are the healthcare information segments.

Another aspect of the invention is a method for providing medical information is provided. The method includes the step of providing a mobile computing device having a user interface, the device being capable of performing a computer executable program. The method also includes the steps of initiating the computer executable program, displaying a plurality of healthcare related subjects on the user interface, receiving a command to select one of the healthcare subjects listed on the user interface, generating a query set associated with the selected healthcare subject, receiving query responses in relation to the query set. The method for providing medical information further includes the steps of assigning alpha numeric values to healthcare topics based upon the query set, ranking the topics based upon the alpha numeric value; and displaying at least one of the healthcare topics. The most relevant topic has the highest value, and the healthcare topics are graphically distinguished based upon the topic relevancy to a malady represented by the query responses.

Another aspect of the invention is a computer readable storage medium containing a set of instructions for a computing device including a user interface. The instructions including the steps of displaying a plurality of healthcare related subjects on the user interface, generating a health care subject list and displaying the list on the user interface, generating a query set associated with a selected healthcare subject, assigning alpha numeric values to healthcare topics based upon the query set, ranking the topics based upon the alpha numeric values, and displaying a multimedia healthcare segment associated with a topic.

### BRIEF DESCRIPTION OF THE DRAWINGS

FIG. 1 is a block diagram of one illustrative example of a health information delivery system in accordance with at least one embodiment of the present invention.

FIG. 2 is a block diagram of one illustrative example of a mobile computing device of the present health information delivery system in accordance with at least one embodiment of the present invention.

FIG. 3 is a flowchart of one illustrative example of a method for delivering health-related information in accordance with at least one embodiment of the present invention.

FIGS. 4A-4B is an exemplary health information subject logic table in accordance with at least one embodiment of the present invention.

FIG. 5 is a diagram of one illustrative example of the mobile computing device of FIG. 2, including a representative screen shot, in accordance with at least one embodiment of the present invention.

FIG. 6 is a diagram of one illustrative example of the mobile computing device of FIG. 2, including an alternative representative screen shot, in accordance with at least one embodiment of the present invention.

FIG. 7 is a diagram of one illustrative example of the mobile computing device of FIG. 2, including an alternative representative screen shot, in accordance with at least one embodiment of the present invention.

FIG. 8 is a diagram of one illustrative example of the mobile computing device of FIG. 2, including an alternative representative screen shot, in accordance with at least one embodiment of the present invention.

FIG. 9 is a diagram of one illustrative example of the mobile computing device of FIG. 2, including an alternative representative screen shot, in accordance with at least one embodiment of the present invention.

FIG. 10 is an exemplary screen shot example of the mobile computing device graphical user interface, in accordance with at least one embodiment of the present invention.

FIG. 11 is an alternative exemplary screen shot example of the mobile computing device graphical user interface, in accordance with at least one embodiment of the present invention.

FIG. 12 is an alternative exemplary screen shot example of the mobile computing device graphical user interface, in accordance with at least one embodiment of the present invention.

### DETAILED DESCRIPTION OF THE INVENTION

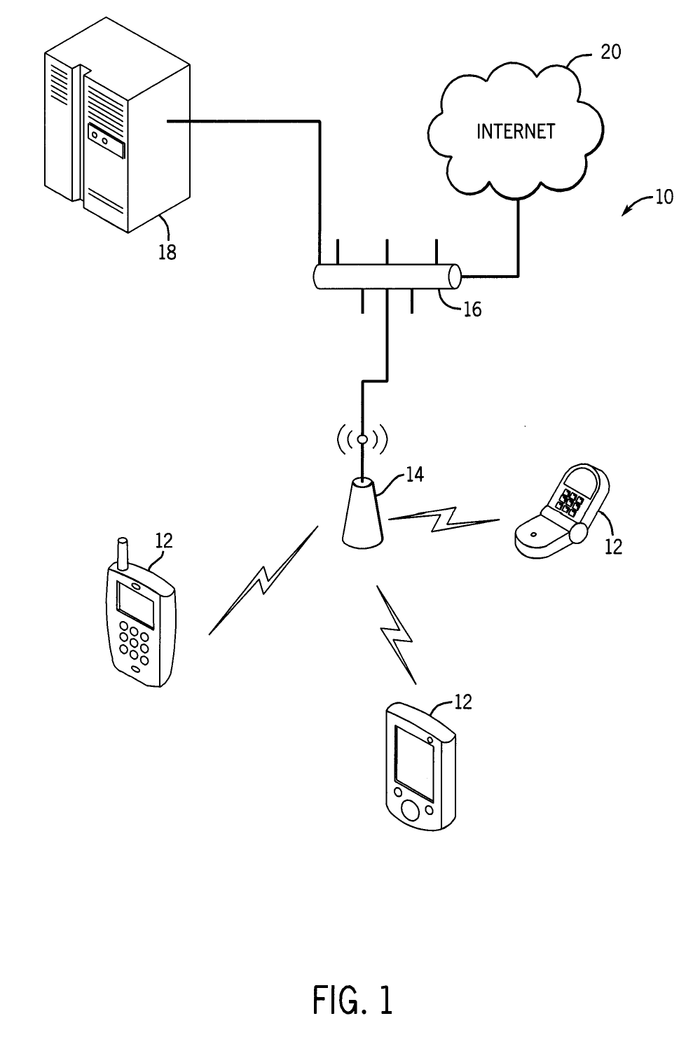

Referring to FIG. 1, an illustrative example of a health information delivery system 10, in accordance with at least one embodiment of the present invention, is shown. The system 10 comprises one or more mobile computing devices 12, a wireless access point 14, a network 16, and a data storage device 18. A connection to the Internet 20 is available through the network 16. Each of the mobile computing devices 12 is selected from a group of devices, including, for example, cellular phones, smart phones, multimedia data storage devices, personal data assistants (PDA), Blackberrys, laptop computers, handheld computers, and tablet PCs. More than one mobile computing device 12 can be in connection with the wireless access point 14, as depicted in FIG. 1. Examples of the mobile device 12 include the Blackberry 8700g (Research In Motion, Inc., Waterloo, Ontario), Motorola Q (Motorola, Inc., Schaumberg, Ill.), iPod (Apple Computers Inc., Cupertino, Calif.), Palm Treo 700p (Palm, Inc., Sunnyvale, Calif.), and HP iPAQ (Hewlett-Packard Inc., Palo Alto, Calif.). The wireless access point 14 provides a wireless connection for the device 12 to the network. The access point 14 can be, for example, a cell phone tower, a wireless router, or a network hotspot.

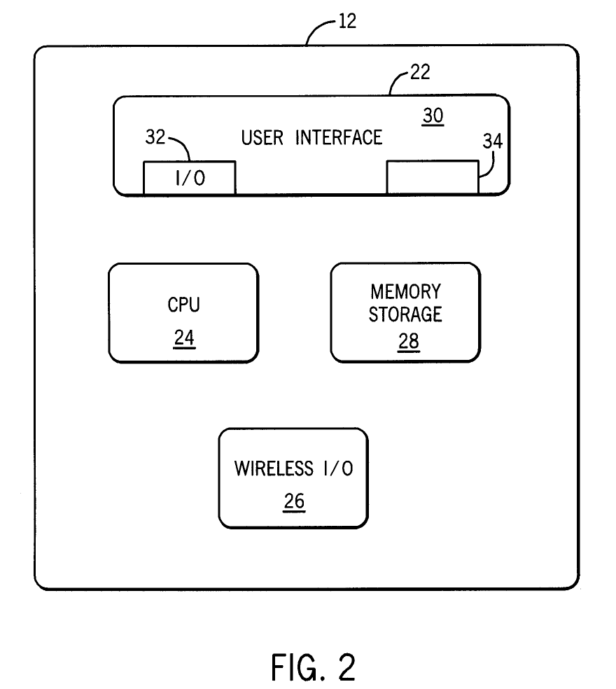

Referring to FIG. 2, the mobile computing device 12 includes a user interface 22, a central processing unit (CPU) 24, a wireless input/output (I/O) interface 26, and a memory storage device 28. The user interface 22 allows the mobile device 12 to be controlled by a user. The user interface 22 allows for the user to interact with the device 12 and to experience multimedia segments or presentations. The interface 22 includes a graphical display 30, an I/O device 32, and a speaker 34. The interface 22 can be connected to the CPU through a BUS structure (not shown). The CPU 24 can be a microprocessor. A variety of interface devices 22 are available, including, for example, keyboards, track wheels, graphical displays, speakers and microphones, touch screens, voice recognition software, and telemetric data I/O (not shown).

The wireless I/O Interface 26 enables the device 12 to send and receive data from the network 16 through a connection to the access point 14. The data storage device 18 is accessed by the mobile device 12 through the computer network 16. The network 16 is an Ethernet network having a connection to the Internet. The data storage device 18 includes a computer readable medium that stores data and allows data to be retrieved. The device can be, for example, a computer having a memory storage device, a database, random access memory, cache memory or a magnetic hard disc. Dynamic data updates are contemplated for keeping the health information current. Alternatively, the network 16 can be the Internet. In an alternative embodiment, the mobile device 12 stores all the accessible data within the memory storage device 28 and a network 16 connection is not necessary.

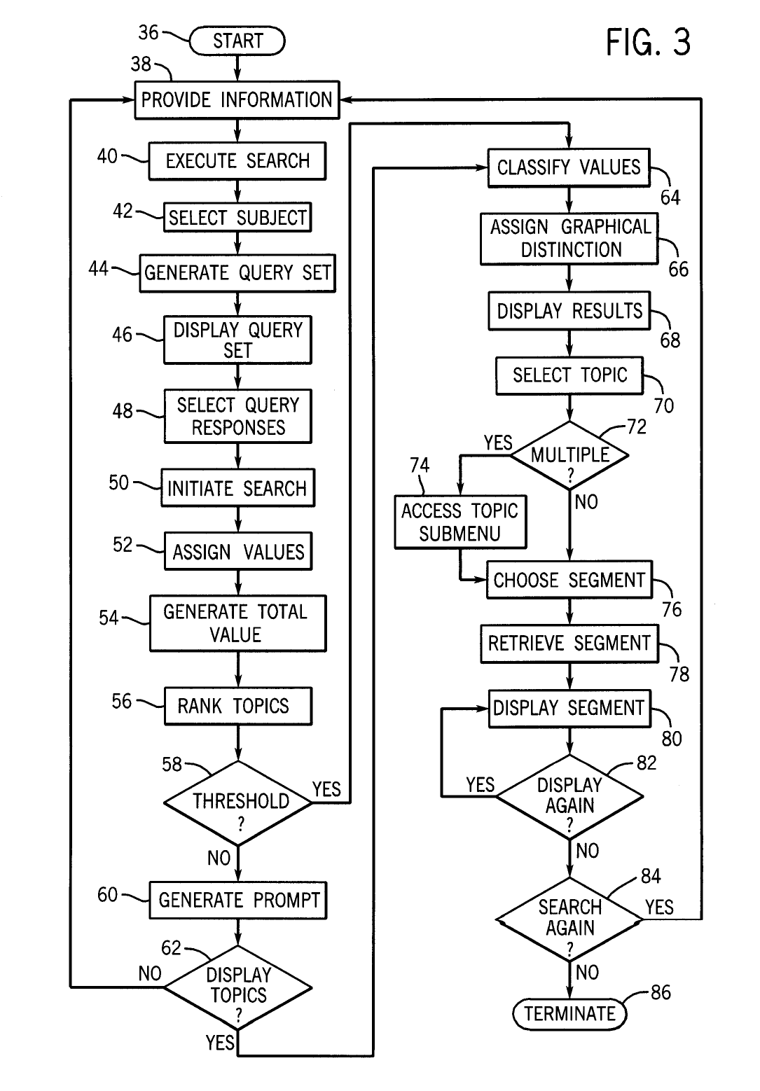

Referring to FIG. 3, a user initiates operation of the mobile computing device by initiating its start sequence at step 36. The user also accesses the interface and initiates the desired computer executable program at step 36. After the user has initiated the program an informational message about the program is provided by the user interface at step 38. By example, program data, commercial advertising, or emergency alert data can be provided. Alternatively, for non-health care professional users, a medical disclaimer is provided for directing users to contact a health care professional. Depending upon the service and data content, users are provided with a disclaimer identifying that the segment content is not meant to replace actual professional medical treatment.

By accessing the interface 22 users can search medical subjects that are of interest. It is contemplated that a user will search for medical subjects seeking information for a specific malady they, or others are experiencing. It is further contemplated that users will access the health information delivery system 10 for general and non-specific information associated with at least one medical subject. Thus, a keyword search is executed and a list of possible subjects within the device memory is provided at step 40. The user can browse a subject index in order to find the sought after data. In an alternative embodiment, the mobile device 12 has a network connection to the Internet 20 or network computer 18 allowing searching for additional data not available in the mobile device memory storage. A mobile device index and memory 28 are dynamically updated in the event that new health care information is available for the mobile computing device executable program.

After the subjects are made available to the user at step 40, the user preferred healthcare subjects are accessible through a hyperlink, which is selected by the user through one of the available interfacing or input devices 22 at step 42. After selecting a particular subject a search query set is generated at step 44 and then displayed at step 46 by the interface 22. Query sets associated with each subject are saved within memory 28 and are accessed by the CPU 24 after the user selects a subject. The query set is a group of binary questions specific to the healthcare related subject previously selected. Each query set is prepared by a panel of healthcare professionals having training, certification, and significant clinical experience with the healthcare related subject and topic of interest. The query set provides a means for focusing a user's healthcare query within a healthcare subject. In an alternative embodiment, the query set is generated in real-time by the CPU 24. The generated query set can include recently updated health information.

Binary responses to the queries include Yes/No, Yes/(No or I don't know) or above or below a defined threshold (Ex. ≧55/<55). In an alternative embodiment actual values are input by the user, which can include biometric data, healthcare history data, and current medical treatment data. Healthcare and healthcare related information includes information relating to subjects associated with medical, dental, and allied health professionals, it further encompasses information relating to the prevention, treatment, and management of illness and the preservation of mental and physical well-being.

After the users select the appropriate query responses at step 48, the search engine is initiated at step 50. Query responses are linked to a pre-existing index of healthcare subjects that is accessed after the search is initiated. In the present embodiment the user interface includes an ENTER button that when pressed, initiates the search. Interface navigation is contemplated by all known interfacing means, including the input devices 22 identified previously. Alternatively a healthcare topic is a healthcare multimedia segment.

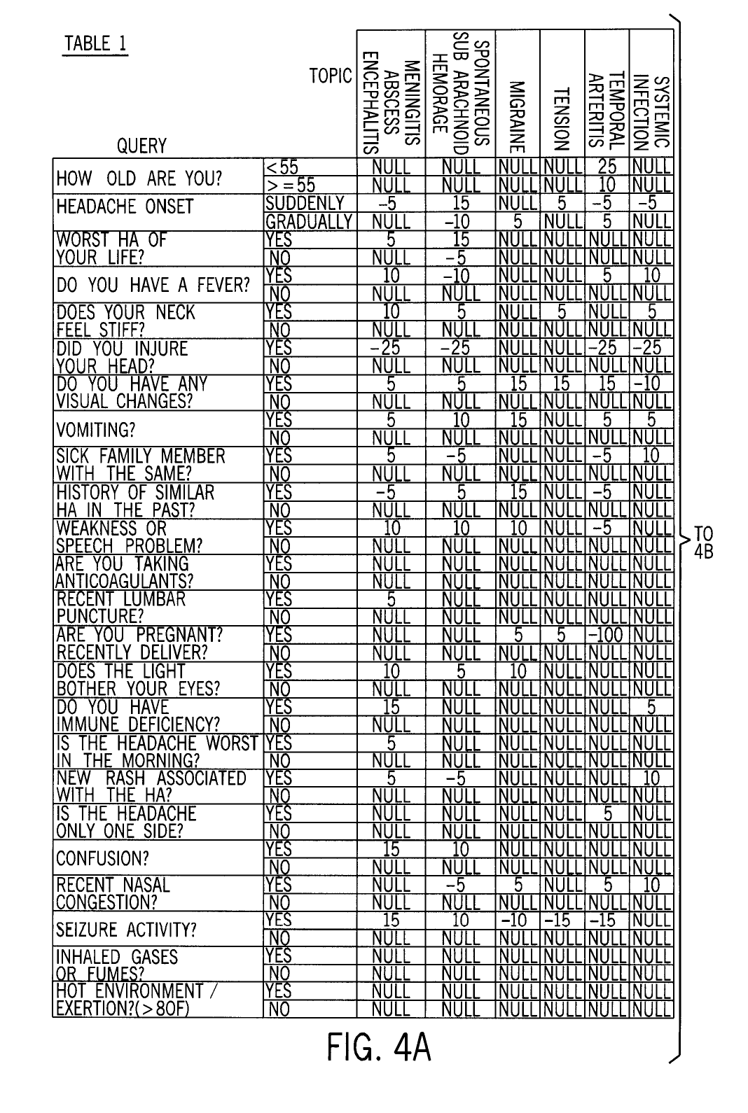

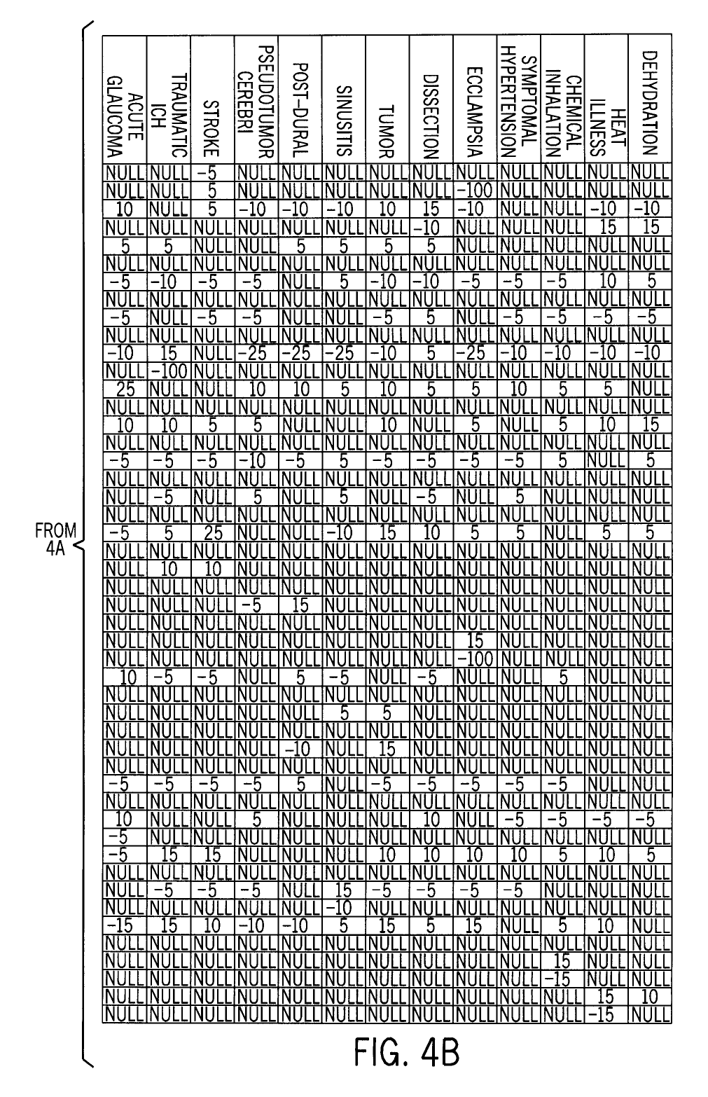

Based upon the query responses, alphanumeric values or scores are assigned, at step 52, to each of the topics based upon the query set responses. Table 1 (see FIGS. 4 A-B) provides an example of values assigned to each query response for a given topic. A total value is generated at step 54 for each topic based upon the query responses. Table 1 represents an alphanumeric scheme of positive, negative and null values. Positive values are assigned where the query response implicates a higher likelihood of relevance for a particular topic. Negative values are assigned where the query response indicates a lower likelihood of relevance for a particular topic. The null value is assigned in cases when the query response has little to no known effect upon the likelihood of relevance based upon the query responses, for a particular topic.

Total values assigned to the topics are ranked at step 56 in order from highest value to lowest value. The highest value will be the largest alphanumeric value; in the case of Table 1 it is the largest positive value. However, the highest value is an arbitrary designation that alternatively will be the lowest negative number or null value in the event that no positive topic value is generated.

The example shown in Table 1 provides nineteen (19) topics (e.g. systemic infection, migraine, tumor, dehydration, and sinusitis), which represent a range in total values. A significant portion of the topics need not to be presented to a user through the user interface due to the lack of relevance to the query responses and the significant differences in topic values. One or more segments can be associated with each topic. A default threshold of ten (10) topics (or, in an alternative embodiment, some other default number) is set thereby limiting the number of topics that will be displayed on the user interface. The user and/or the system administrator can set the threshold value, which can be based upon a maximum number of topics. In an alternative embodiment the threshold value is based upon the total value assigned to the highest topic total value, which is based upon the query responses. In the event that no topic receives a total value that meets or exceeds this threshold at step 58, the user can set the program to display as many or as few, including zero, topics that don't meet the threshold. A prompt is then generated at step 60 and provided to the user indicating that no topic was deemed highly relevant. The prompt at step 60 further requests the user to provide more information.

Although a threshold for cutting off the number of topics will aid in identifying the most relevant topics, there can also be a significant range of values between the most relevant topic and the least relevant topic that meets the threshold value. Sub characterizing the topics by relevancy clustering can provide the user with further information as to which topics are of greater vs. less relevance. A second, third or fourth level tiered system can accomplish the sub characterization based upon the system administrator and the perceived needs of the user. A determination of whether to display the topics is made at step 62. If the topics are not displayed then step 38 is repeated. Otherwise topic values are assigned a classification at step 64 based upon the magnitude of the value as compared to the other values. Values that did not meet or exceed the threshold limit are assigned an irrelevant classification. The lowest values to meet the threshold can also receive this classification based upon the classification scheme. The remaining classes in a four-tiered system, by example, include major, moderate, and minor.

Tiered or classified topics are based upon the highest topic value, which is represented by the variable (x). Topics assigned the major classification represent topics having a value within a range of about (x) to about 0.75(x). Moderate, minor, and irrelevant are within the ranges of about 0.5x to about 0.74x, about 0.25x to about 0.49x and about zero to about 0.24x respectively (see Equation Set (1)). The number of topics assigned to each classification or category is not limited due to the absolute value assigned. Major and moderate classified topics are provided to the user through the user interface. The system administrator can alternatively provide a combination of the categorized topics. In an alternative embodiment the absolute value assigned to the categories is (x) to 0.90(x), 0.70(x) to 0.89(x), 0.60(x) to 0.69(x) and 0.0(x) to 0.59(x) for major, moderate, minor and irrelevant respectively (see Equation Set (2)). In yet another alternative embodiment, a three-tiered system, by example, includes the categories high, medium and low. In an alternative embodiment a five tiered classification is set. In yet another alternative embodiment the topics are categorized based upon their total values by a data clustering algorithm. Various types of data clustering techniques are contemplated, including hierarchical and partitional clustering. For hierarchical clustering the distance measure is based upon the total value assigned to each topic. Alternative known distance measuring techniques are also contemplated.

x=Highest total topic value

x>0.75x=Major

0.74×0.50x=Moderate

0.49×0.25x=Minor

0.24×zero=Irrelevant Equation Set (1)

x=Highest total topic value

x>0.9x=Major

0.89x>0.7x=Moderate

0.69x>0.6x=Minor

0.59x>zero=Irrelevant Equation Set (2)

Once the topics have been distinguished based upon the tiered classification scheme they are visually distinguished from each other at step 66. The visual distinction is displayed at step 68 by the user interface and represents the presence of tiered relevancy for the topics provided. The topics are visually distinguished in a variety of ways including, different color schemes, varying font sizes, varying font styles, addition of alternate characters associated with the various tiers, and indenting. In an alternate embodiment, the categories are separated by distinct links and sub-menus listing the topics assigned to that particular category.

Once the user desires to view a topic from the customized list of generated health topics located on the deck of the mobile handheld device the user would activate the user interface 22 link. Once again, the activation of the link could be manual (i.e., by clicking), voice, or telemetric. This process request occurs with minimal latency because it is an integrated function executed by the device's operating system. Once the topic is selected at step 70 a client (mobile handset user) to server (e.g., wireless application provider site) method is used to access the relevant health information archived in a digital format. The digital media-based content is accessed from memory 28 or delivered over a wireless broadband network 16 to remote mobile handset users. If the content is delivered over the network 16 it can be assessed from the Internet 20 or the memory 18. The user can now view his or her personalized health information segment. An alternative method would be for the user to download the entire health content database onto their mobile handset's hard drive and obviate the need for client-server data transfer. The links would access health content directly from the mobile handset device hard drive.

A topic is selected by the user at step 70 however a determination is made at step 72 as to whether there are multiple segments associated with a single topic. If there is more than one segment associated with each topic, then a submenu containing those segments is accessed at step 74. A healthcare information segment is then chosen by the user at step 76, and retrieved at step 78 from the database 18 before it is displayed at step 80 by the user interface 22. Alternatively, the segment can be viewed directly after selecting the topic at step 70. The user can select to view the segment again at step 82 or to perform another search at step 84. If the user selects not to continue, the program terminates at step 86, otherwise step 38 is repeated.

Health information segments range in content, form, and playback length. Based upon theses variables the segments have a significant range of data file sizes. The segment data files can be in a variety of formats, including Quicktime Video (.mov), Real Media (.rm, .ram), Windows Media Video (.wmv), Flash Video (.flv, .snf), and Images (.jpeg, .jpg, .gif, .png, etc.). The segment files are retrieved or downloaded from a network database 18. Alternatively, the segment files are saved and retrieved from the mobile device memory storage 28. The database 18 can be accessed through the wireless interface 26. Data download speeds vary greatly between wireless systems and the mobile device 12 capabilities. Data can be retrieved at a data speed, for example, selected from a group that includes EDGE, 1xRTT, VMTS, HSDPA, EV-DO, and GPRS. Additionally, the mobile device operating system is selected from a group that includes Palm OS, Windows mobile, Blackberry and Symbian.

The multimedia health information segments provide self-contained information, in the form of stories, specific to various healthcare related topics and included within various healthcare related subjects. Through the present embodiment, consumers receive rapid access to health information regarding a broad spectrum of healthcare conditions and scenarios. The healthcare conditions include any type of medical information, including emergency, urgent, non-emergency and preventative medical related information. The health segments, also referred to as Medisodes™ health segments, are generally short and limited to a running time of approximately 30 seconds to 2 minutes. Depending upon the particular Medisode™ health segment the running time may be shorter or longer ranging from about twenty (20) seconds to about five (5) minutes. The health segments provide rapid and concise healthcare information in a mobile format, best suited for users with little medical training who do not have ready access to a health care provider. Alternatively, after viewing the healthcare segments further information can be displayed on the user interface. The information, by example, includes the nearest hospital or urgent care facility, a map from the user's current location to the nearest hospital or urgent care facility, and a list of healthcare professionals that are topic specialists or provide treatment for the healthcare topics viewed by the user.

Searching through the user interface allows the user to rapidly identify, retrieve, and view relevant health information through the mobile device 12. The query sets serve as a decision support tool by providing users relevant health information anytime and anyplace.

Healthcare segments provide consumers with immediate and widespread access to useful health information. The segments improve consumers' abilities to make knowledgeable decisions regarding their healthcare. The segments offer mobile wireless media companies a distinctive brand of programming designed to appeal to specific market segments. The segments can easily be translated to foreign languages and provide similar benefits in international markets.

The multimedia segment can be implemented by a variety of known distributed multimedia and application software programs. By example, Flash Light 2.0 (Adobe Systems Inc., San Jose, Calif.) is a distributed multimedia application player designed for mobile phones and other portable computing devices. Alternatively, the BREW (Qualcomm Inc., San Diego, Calif.) and the J2ME (Sun Microsystems Inc., Santa Clara, Calif.) applications can be used. Segments can be formatted in a variety of known file formats, based upon the network protocol utilized. Third Generation (3G) mobile phone system specifications are used to implement the present embodiment. The 3^{rd} Generation Partnership Protocol (3GPP) using a standard based upon evolved Global System for Mobile Communications (GSM) standards, also referred to as the Universal Mobile Telecommunications System (UMTS), is used to implement the present embodiment. Code Division Multiple Access (CDMA) 2000 is an alternative form of a 3G technology standard that can be used. Segment video is optimized for use in mobile computing devices and can be compressed. The present embodiment utilizes a compressed 10-15 frames per second (fps) and screen resolution dimensions of about 176×186. Streaming Video is optimized for data rates of 50-60 Kbps. Encoding and compression is performed using a simplified MPEG-4 compression algorithm or H.263 (3GP protocol).

The present embodiment presents a potential emergency situation. The health segment rapidly provides succinct critical health information. By example, a ‘headache’ topic results in specific topic questions or queries posed to the user. The questions are in binary form, typically a yes/no format. Alternately, the binary format may be above or below a threshold. By example, Age ≦50, >50. Depending upon the users input, a list of Medisodes™ health segments are provided.

As an example, the user chooses headache, a binary entry interface 22 is provided. The user indicates ‘Yes’ to symptoms including a ‘Sudden Onset?’ and ‘Worst Headache Ever?’ The user then enters the information and the system 10 runs the entries against the algorithm. Based upon these entries, a list of topics is provided, the list being ranked by relevancy. A list is generated based on the values in Table 1 (FIG. 4A-B) and includes, healthcare segments for Subarachnoid Hemorrhage, Meningitis Abscess Encephalitis, Acute Glaucoma, Symptomatic Hypertension, Migraine, Stroke, Systemic Infection, Tension and Tumor.

By example, the health information segment is selected from an extensive list of medical conditions that can be symptom based (e.g., chest pain, shortness of breath, etc.), sign based (e.g., rash, swollen leg, etc.), or condition-based (e.g., acute bronchitis, acute glaucoma, anaphylaxis, etc.). The database 18 is medical content agnostic and can contain emergency medicine or alternative medical and surgical specialty content (e.g., obstetrics and gynecology, trauma surgery, transplant surgery, endocrinology, etc.). The breadth and volume of information contained in the database 18 is extensive and can contain thousands of healthcare entries.

An alternative example includes the use of 2G networks and existing consumer mobile devices, such as 2G cell phones currently in use. On-demand digital multimedia (text, images, and diagrams) provides the broadest segment of handset users access to health information. The primary difference is the omission of digital video due to handset limitations.

An alternative example includes the use of 4G networks with 4G enabled mobile devices. On-demand digital multimedia clipcasts are downloaded or streamed using existing air interfaces to mobile devices 12. Consumers select from a menu of health topics (e.g., bee sting, headache, diarrhea, etc.) presented on a customized user interface and receive immediate access to specific health information. Enhanced data rates and multimedia operability are implemented, including HDTV and wireless broadband internet connectivity.

### HEADACHE EXAMPLE

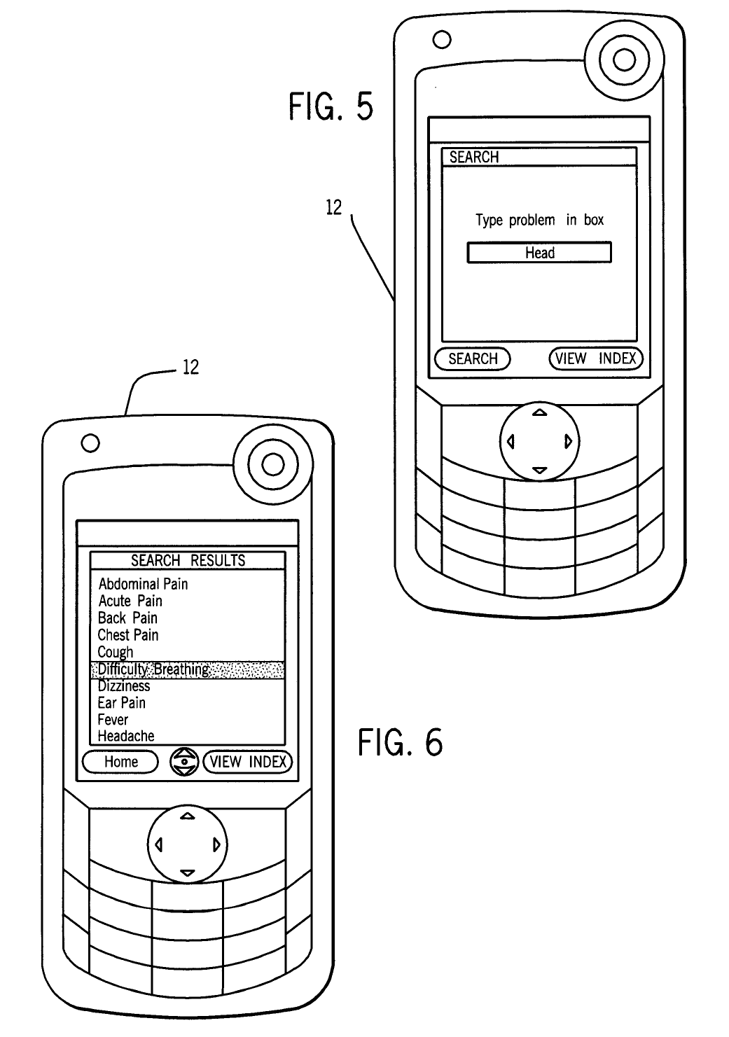

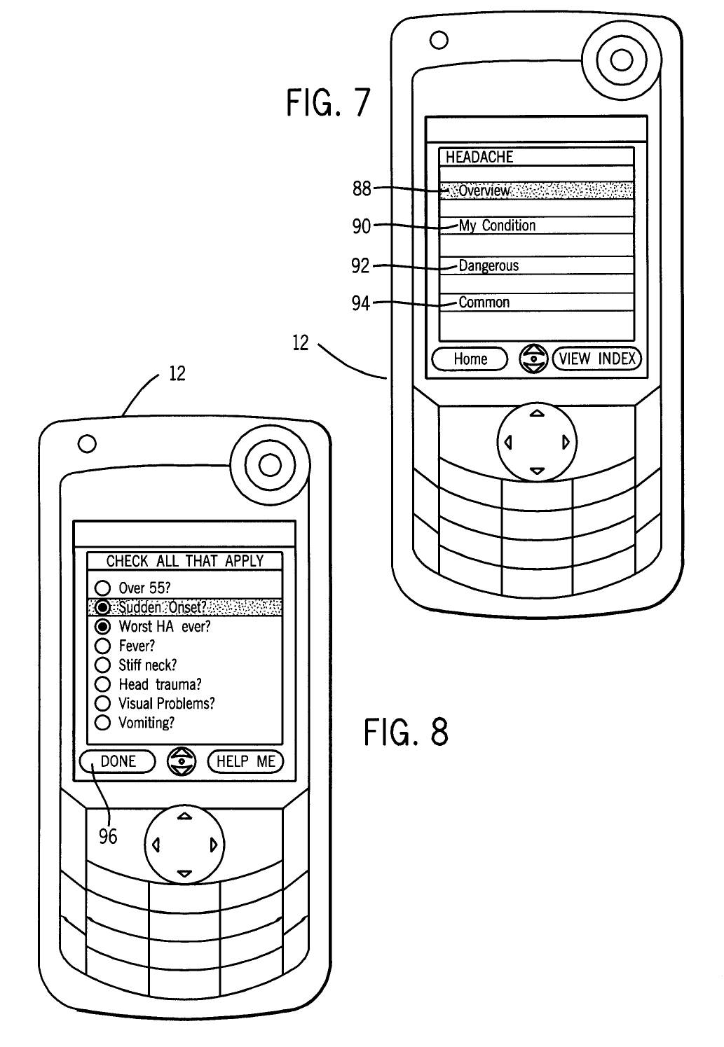

Referring to FIGS. 5-9, a mobile device 12 is depicted with illustrative screen shots. The user accesses a computer executable program by selecting the required keystrokes through the user interface 32 on the mobile device 12. The health related computer executable query sets are previously loaded onto the memory device 28. Once the computer executable application is accessed the user identifies a medical condition from the general category list available by entering in a key word. FIG. 5 represents a user entry for “head”. A key word search is requested by the user and a list of search results is displayed on the user interface in FIG. 6. Alternatively, the user can avoid a key word search and access an on-deck master index of subjects. The user can scroll through the search results (see FIG. 7) or the master index (not shown) and select the subject option they wish (see FIG. 3, step 42).

Subsequent to selecting the subject feature (FIG. 6), the user interface displays an options screen, as shown in FIG. 8. The options screen provides an overview section 88, a my condition section 90, a dangerous section 92, and a common section 94. When accessed through the user interface, the overview section 88 provides information generally known about the subject, in this case headaches. Clicking on the overview section 88 provides the user with a general description of headaches presented in the form of a multimedia based thirty (30) second to two (2) minute segment on health related subject matter. The multimedia segment can alternatively range from twenty (20) seconds to five (5) minutes. The segment provides highly relevant information in a succinct and clear manner. Audio and video information is provided. Alternatively, the user can scroll through or search through the overview section 88 to obtain succinct textual-based information about headaches.

The condition section 90 allows the user to provide personal medical information that when the computer executable program processes the personal medical data a list of highly relevant topics are provided. The dangerous section 92 provides access to medical information regarding headaches that are deemed dangerous, critical, or emergency related medical conditions. Clicking on the dangerous section 92 generates a list of the most dangerous causes of headaches, clicking on any of which would launch a corresponding multimedia based segment on headaches. The common section 94 provides medical related information specific to headaches that provide a user with common causes of headaches. A corresponding list or single multimedia segment is provided that includes the most common causes of headaches. Common treatments and actions that can be taken to reduce future headaches is displayed by the user interface 22. Data available through the user interface 22 is stored within the mobile devices memory storage 28. Alternatively, the data is accessible through a wireless I/O interface 26, thereby accessing a remote network 16 and computer 18, and retrieving the data from the remote computer via the network 16 and wireless I/O interface 26.

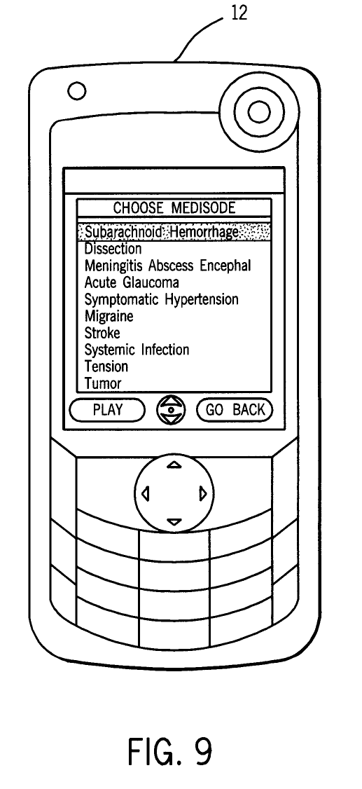

Accessing my condition section 90 provides a prompted series of clinical questions (see FIG. 3, step 46) related to headaches, as depicted in FIG. 8. The answers to these clinical questions are used to query the medical database on headaches and then order (or reorder) the relevant health topics from most relevant to least (see FIG. 3, step 56) and then displayed through the user interface 22 (FIG. 9). Each of the health topics in the present illustrative example are all causes of headaches, and include at least one corresponding multimedia presentation.

FIG. 8 represents a user response to the queries. The user has selected “YES” to the questions “Sudden Onset?” and “Worst HA ever”. The responses represent that the user has indicated that it was a sudden onset headache and that the headache experienced by the user is the worst headache they have experienced. The remaining queries were not changed, which indicates that the user elects to answer “NO” or “I DON'T KNOW”, as the two answers are treated equally and the executable instructions are designed to calculate the two answers as one answer. Additional queries available for the headache subject include the following: Sudden Onset; Fever; Stiff Neck; Head Trauma; Visual Problems; Vomiting; Sick Family Members; Similar Headache Before; Weakness or Speech Problems; Using Blood Thinners; Recent Lumbar Puncture; Pregnant; Light Insensitivity; Immunodeficient; Worst in A.M.; Rash; Unilateral Headache; Confusion; Nasal Congestion; Recent Seizure; Gas or Fume Exposure; and Hot Environment. Each of the queries represent a question posed to the user, in the event that the answer is “YES” the user selects the corresponding query section and the user interface is altered to visually represent that the answer has been changed from the default answer. The queries are set to “NO/I DON'T KNOW” as the default answer.

Following the query response data entry, the done section 96 is selected, which generates a list of topics. The topics are listed in order of relevance based upon predefined parameters and the query responses provided by the user (see FIG. 3, step 68). FIG. 9 depicts an illustrative list of relevant topics that is resultant from the sample query search criteria stated above. The list of topics in order of relevancy includes the following: Subarachnoid Hemorrhage; Dissection; Meningitis Abscess Encephalitis; Acute Glaucoma; Symptomatic Hypertension Migraine; Stroke; Systemic Infection; Tension; and Tumor. The multimedia segment provides a succinct and highly relevant presentation for the user. Table 1 provides a list of topics and queries associated with the headache subject. Each topic in Table 1 includes a segment associated with each it. The search results (FIG. 9) contain a finite list of relevant topics based upon the search query responses. The Subarachnoid Hemorrhage topic is provided at the top of the list because it is the most relevant topic based upon the query answers. The topic relevancy is based upon a value associated with each query response for a particular topic. In the present illustrative example Subarachnoid Hemorrhage has a value of thirty (30), whereas Heat Illness has a value of negative five (−10), based upon he values in Table 1 and the query responses in FIG. 8. The Heat Illness topic is not provided with the search results because the value associated with it, based upon the query answers is below a relevancy threshold. The threshold is set at negative eight (−8), and the Heat Illness topic has a value of (−10) based upon the values in Table 1 and the query responses in FIG. 8. The relevancy threshold can be predefined by the system administrator, having a default value set at a total of ten (10) listed topics.

### DIARRHEA EXAMPLE

In addition to young children and infants, adults frequently encounter diarrhea, and the problem may be particularly dangerous for aged adults. Although adults have a more developed immune system more capable of protecting the host from pathogenic attacks, immuno-compromised adults, and even healthy adults, are frequently subjected to attacks of diarrhea due principally to the ingestion of contaminated water or food.

Even short periods of diarrhea significantly alter the intestinal absorption of ingested food and liquids in adults, threatening the health of the adult. At the very least, acute diarrhea is a troubling and inconvenient illness. Persistent and chronic diarrhea are more dangerous, since these conditions often result in malnutrition and an increasingly weakened immune system, permitting the host to be invaded by other opportunistic infections. With the elderly as well as young children and infants, diarrhea can be life threatening.

Users are not often aware of different types of diarrhea and the treatments of the less encountered types. The current therapy for traveler's diarrhea is to initiate treatment with agents such as bismuth subsalicylate, Loperamide or agents such as Kaopectate in combination with rehydration therapy. The majority of the treatments involve the non-specific removal of the offending agents (i.e. toxins) from the intestinal tract. Only in moderate to severe cases of diarrhea where distressing or incapacitating symptoms are reported is antimicrobial therapy recommended. Antibiotics are not usually effective at reducing clinical symptoms of the disease and problems associated with antibiotic resistance can occur. A therapy is needed which would involve the specific removal of enterotoxigenic E. coli and/or LT activity from the intestine. This would lead to more rapid recovery and/or the lessening of symptoms in individuals who are suffering from diarrhea.

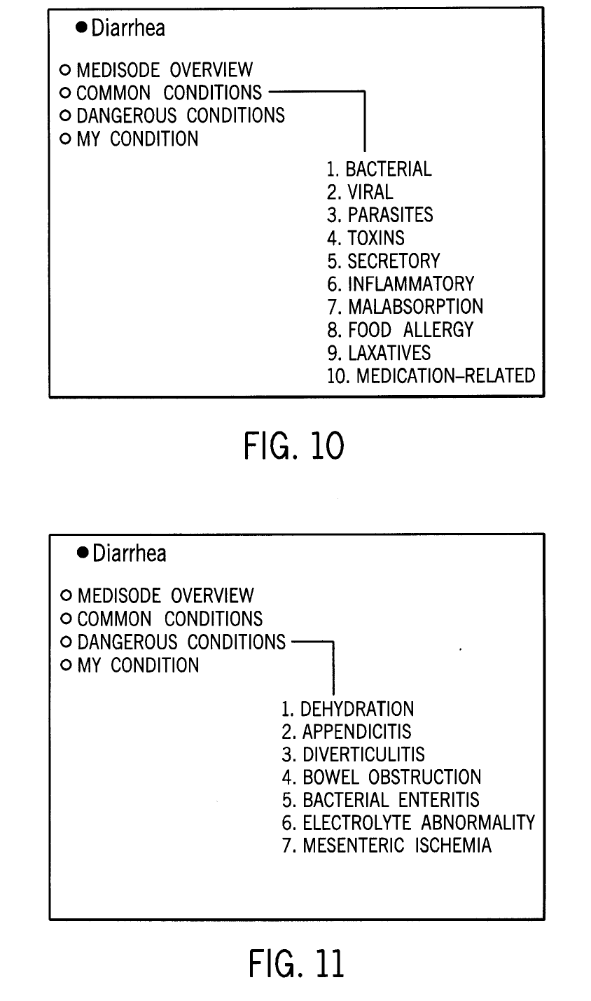

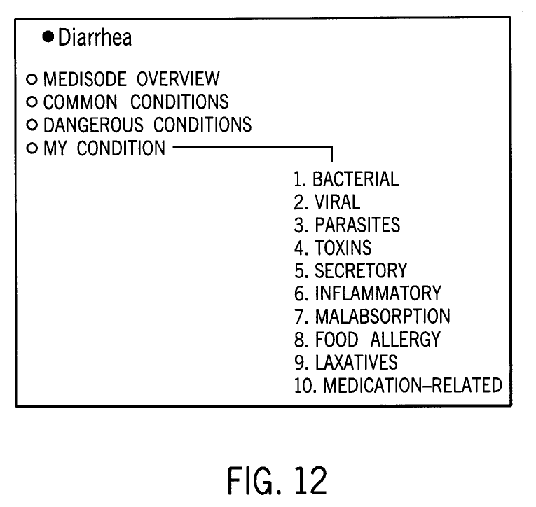

Another example is shown in FIGS. 10-11. A user with diarrhea opens up the software program, saved in the memory of a mobile handheld computing device, to assist with determining the possible causes associated with the complaint of diarrhea. The user is directed to a navigation screen (See FIG. 6).

The user clicks on the common conditions tab to see the most common diseases causing diarrhea (FIG. 10). A diarrhea overview section is provided that includes a multimedia presentation, accessible from the device memory or through a wireless network connection. Alternatively, the user clicks on dangerous conditions section to see the most dangerous causes of diarrhea (FIG. 11). The user can click on the my condition section and search for a succinct presentation providing relevant health information.

The user is presented with a series of clinical questions (see FIG. 3, step 46) related to the clinical problem. The answers to these clinical questions are used to query the medical database on diarrhea and then order (or reorder) the relevant health topics from most relevant to least (see FIG. 3, step 56). The present embodiment incorporates the answer to the clinical questions posed along with utilizing the answers to previous clinical questions to query the database and generate personalized health information.

The present embodiment includes a customized user interface that can be loaded onto a handheld computerized mobile device 12. This interface 22 allows a user to access health information classified by frequency and severity of a medical condition. The interface also allows a user to input information that is used to create a relevant list of medical topics (see FIG. 3, step 68) based on signs or symptoms of an illness they are inquiring about. The user's binary inputs into the user interface are linked to a pre-existing index of medical topics. The order of the medical topics can be rearranged, from most to least relevant, based on user inputs. These lists can be created by a panel of expert healthcare professionals with training, certification, and significant clinical experience with the healthcare conditions listed.

Once a user is satisfied with the degree of personalization of health topics they can access a topic. Thus far, all processes are occurring with the operating system of the mobile handheld device 12. Once content is desired, a broadband wireless network 16 would transmit the request and subsequently deliver the requested digital media content to the mobile handset user. The user is now able to play, pause, rewind, and replay the downloaded health information (see FIG. 3, step 78) segment. This process requires the creation of a database of health information content that can be delivered via a client (mobile handheld device 12) and server method. Alternatively, the entire health content is downloaded onto the hard drive of the mobile handheld device 12. This obviates the need for broadband wireless transmission of information.

### YELLOW JACKET STING EXAMPLE

An alternative illustrative example includes the medical subject of insect stings or bites. Query sets and topics are provided for various stings from insects of the order Hymenoptera, which include bees, wasps, hornets and ants.

Venomous bites and stings can cause a variety of reactions depending upon the source of the venom and the sensitivity of the individual or animal. In some cases, venom from a bite or sting can cause anaphylaxis, an immediate hypersensitivity which can be life-threatening. In other cases, certain venoms can cause cutaneous “local” reactions. Cutaneous local reactions can be characterized as 1) “non-allergic” reactions which are of limited size and duration or as 2) “allergic” or “large” local reactions which are typically larger in size and longer in duration. With regard to Hymenoptera venoms, which include bee, wasp, hornet and yellow jackets, the non-allergic local reaction is a toxic response to venom constituents, while the large local reaction appears to be caused by an allergic reaction to venom proteins.

Upon receiving a venomous bite or sting, a variety of symptoms can be exhibited due to the venom, including pruritus, erythema, urticaria, angioedema, soft tissue swelling, inflammation of the affected area and pain in the affected area. When injected subcutaneously, many venoms from bites and stings induce extravasation from adjacent blood vessels.

Patients stung by a bee typically will develop redness, pain, and swelling of the skin within minutes. A stinger may remain in the skin following Bumble Bee stings. The careful removal of the stinger is thought to lessen the chance of secondary bacterial skin infection. The swelling can progress and last for several days. If the bite is in the oral cavity or lips, blockage of airflow to the lungs can occur. Patients can also develop severe allergic reactions to the venom of bees, wasps, and hornets. Life-threatening allergic reactions often cause redness and flushing of the entire body, difficulty breathing, weakness, low blood pressure, and loss of consciousness. Isolated stings are often treated with cool compresses, over-the-counter antihistamines to control itching, and observation. On occasion, steroids (e.g., prednisone) are prescribed to limit swelling in with more severe envenomations. Patients with a history of life-threatening allergic reactions are often prescribed epinephrine pens. The small and portable injections kits provide patients with severe allergic responses immediate access to a potentially life-saving medication. The pain, swelling, warmth, and redness at the site of the sting often increases for 12 to 24 hours then resolved over 48 to 72 hours.

After being stung by a yellow jacket for the first time, a user is in need of fast and relevant information to assess the situation. The user selects the medical informational delivery program on her smartphone 12. The user performs a key word search for “Bee Sting” and is provided a list of subjects. The insect bite/sting subject is the most relevant subjected and is selected by the user (see FIG. 3, step 42). A query set is generated, which asks questions related to the symptoms and type of insect that caused the situation (see FIG. 3, step 44). After answering all the questions the user is provided a list, which is ranked by relevancy (see FIG. 3, step 68). The first topic is “yellow jacket sting,” which the user selects (see FIG. 3, step 76). She is provided a concise summary of expected signs and symptoms, danger signals, and typical treatment measures in a two-minute or less digital multimedia format (text, images, graphics+/−video).

Subsequent to viewing images of the natural course of yellow jacket stings, danger signs, and learning bee sting management thru the health segment, she is better informed. She can now make a more appropriate decision on how, when, and if she should seek professional medical care. In the event that the medical condition is serious enough, the user can utilize the nearest hospital or urgent care facility information provided on the interface 22. Alternatively, the CPU 24 can generate a prompt to schedule a healthcare professional appointment of the user's choice and timing.

In an alternative embodiment, it is contemplated that the multimedia healthcare segments can be customized for multicast viewing with corresponding long-form video programming. The healthcare segments can serve as an “add-on” to more detailed programming similar to extra features seen on DVD programming. For example, a marine animal envenomation healthcare segment can follow a program on skin diving in coral reefs. Alternatively, healthcare segments can serve as their own form of short programming formatted specifically for multicasting to mobile handsets 12.

It is further contemplated that a web-based version of the invention can be accessible via the Internet. Individual PCs or MACs having access to the Internet can provide users the ability to access the relevant healthcare information and view the selected healthcare information segments wherever they maintain an Internet connection. Corresponding changes in the delivery of the multimedia segments for varying computing devices is contemplated, including expanded frames per second and video resolution. Alternatively, the healthcare delivery system can be completely maintained within a memory storage device of a PC or MAC based computing device. Updates can be accessed via the Internet or saving data from a portable memory storage device.

Embodiments of the present invention will aid in decreasing healthcare costs, as the system identifies, retrieves, and delivers relevant health information that assists users with making more appropriate healthcare-related decisions. An estimated 11% of total annual emergency room visits are for non-emergency medical conditions. By reducing a fraction of the unnecessary ER visits healthcare costs will be reduced.

Embodiments of the present invention provide mobile handheld device users with customized health information. The system 10 adapts to the amount of information (e.g., limited or detailed) provided by the user to provide and order a list of relevant health topics that can be reviewed. Embodiments of the present invention reorder the list of health topics from most relevant to least relevant based on user data inputs. In this fashion, the user is able to identify the conditions most-associated with his or her primary complaint and the associated medical findings. Rather than providing a generic list of possible diagnoses, the medical reasoning engine or CPU 24 uses information from complaint-related queries to personalize health information.

It is further contemplated that integration of location-based services, two-way data streaming, and sensor technology to optimize user experiences can be provided. The various embodiments are given by example and the scope of the present invention is not intended to be limited by the examples provided herein.

Although the invention has been described in detail with reference to preferred embodiments, variations and modifications exist within the scope and spirit of the invention as described and defined in the following claims.

1. A mobile computing device comprising:
a user interface;
a central processing unit (CPU) for performing computer executable instructions;
a wireless interface for data export and retrieval; and
a memory storage device for storing computer executable instructions that when executed by the CPU cause the CPU to perform a process for ranking a list of healthcare related information topics by relevancy based upon responses to a query set, the query set being specific to a healthcare related subject, wherein a healthcare related information segment is associated with the topic, the healthcare information segment being a multimedia presentation executed by the mobile computing device.

2. A healthcare information delivery system comprising the mobile computing device according to claim 1 and further comprising:
a network memory storage device for storing multimedia segments;
a computer network connected to the network memory storage device;
a wireless access point for connecting the mobile device to the computer network, wherein the multimedia segments are requested from the network memory storage device by the mobile computing device, the requested multimedia segments being the healthcare information segments.

3. The mobile computing device according to claim 1, wherein the standard playback time of the health information segments is between about twenty (20) seconds and about five (5) minutes.

4. The mobile computing device according to claim 1, wherein the health information segments are retrieved from a database.

5. The mobile computing device according to claim 1, wherein the mobile device is selected from the group consisting of a mobile phone, a mobile smart phone, a digital music player, a pocket PC, and a handheld device.

6. The mobile computing device according to claim 1, wherein query search results are assigned an alphanumeric value, the search results value being calculated by first assigning an alphanumeric value to query selections associated with a topic.

7. The healthcare information delivery system according to claim 2, wherein data is accessed from a group of networks consisting of a 2G network, a 3G network, a 3.5G network, a 3.75G network, a 4G network, the Internet, and a IEEE 802.11 network.

8. The healthcare information delivery system according to claim 2, wherein data is retrieved at a data speed selected from the group consisting of EDGE, 1 xRTT, UMTS, HSDPA, EV-DO, and GPRS.

9. The healthcare information delivery system according to claim 2, wherein a mobile computing device operating system is selected from the group consisting of Palm OS, Windows mobile, Blackberry, and Symbian.

10. The healthcare information delivery system according to claim 2, wherein the query responses are binary query responses, the segments being generated based on the binary responses.

11. The healthcare information delivery system according to claim 2, wherein the list is in part generated by removing results having values below a pre-defined threshold value.

12. The healthcare information delivery system according to claim 2, wherein the subject is Emergency Medicine and the topic is a selected multimedia Emergency Medicine segment, wherein the topic is highly relevant to an emergency malady, the selected segment distinguished from at least one other Emergency Medicine segment, the segments being represented in a multi-tiered format.

13. (canceled)

14. (canceled)

15. (canceled)

16. The mobile computing device according to claim 6, wherein the search query is in binary form having two possible responses, the query responses having an alphanumeric value associated with a topic.

17. (canceled)

18. The healthcare information delivery system according to claim 12, wherein the list is presented graphically in a multi-tiered format.

19. The healthcare information delivery system according to claim 18, wherein the multi-tiered format is selected from the group consisting of color schemes, varying font sizes, varying font styles, alternative character associations, and indenting.

20. The healthcare information delivery system according to claim 12, wherein query search results are assigned an alphanumeric value, the search results value being calculable by first assigning an alphanumeric value to query selections associated with a topic.

21. The healthcare information delivery system according to claim 12, wherein the medical subject selected from the group consisting of Allergies, Cardiology, Dermatology, Endocrinology, Gastroenterology, Genitourinary, Renal, Geriatrics, Neurology, Oncology, Hematology, Orthopedics, Rheumatology, Gynecology, Obstetrics Pediatrics, Preventative Medical Information, Pulmonology, Surgical and Psychiatric.

22. (canceled)

23. (canceled)

24. The healthcare information deliver system according to claim 16, wherein the health information segment is selected from a group of medical conditions consisting of symptom based conditions, sign-based conditions, and condition-based conditions.

25. (canceled)

26. A method for providing medical information, the method comprising:
providing a mobile computing device having a user interface, the device being capable of performing a computer executable program;
initiating the computer executable program;
displaying a plurality of healthcare related subjects on the user interface;
receiving a command to select one of the healthcare subjects listed on the user interface;
generating a query set associated with the selected healthcare subject;
receiving query responses in relation to the query set;
assigning alpha numeric values to healthcare topics based upon the query set;
ranking the topics based upon the alpha numeric value; and
displaying at least one of the healthcare topics, the most relevant topic having the highest value, wherein healthcare topics are graphically distinguished based upon the topic relevancy to a malady represented by the query responses.

27. (canceled)

28. (canceled)

29. The method for providing healthcare information from a mobile computing device according to claim 26, further comprising:
accessing a computer network through a wireless network access point; and downloading a healthcare segment from a network memory storage device.

30. The method for providing healthcare information from a mobile computing device according to claim 26, further comprising:
removing topics from a query results list, the topics having an alphanumeric value below a pre-defined threshold value; and displaying the list in a multi-tiered format on the user interface.

31. (canceled)

32. (canceled)

33. (canceled)

34. The method for providing healthcare information from a mobile computing device according to claim 26, wherein the topic is a multimedia segment.

35. (canceled)

36. (canceled)

37. (canceled)

38. (canceled)

39. (canceled)

40. (canceled)

41. (canceled)

42. A computer readable storage medium containing a set of instructions for a computing device having a user interface, the set of instructions comprising:
displaying a plurality of healthcare related subjects on the user interface;
generating a health care subject list and displaying the list on the user interface;
generating a query set associated with a selected healthcare subject;
assigning alpha numeric values to healthcare topics based upon the query set;
ranking the topics based upon the alpha numeric values; and
displaying a multimedia healthcare segment associated with a topic.

43. The computer readable storage medium according to claim 42, wherein the computing device is a mobile device, the segment being formatted for use on the mobile device.

44. The computer readable storage medium according to claim 42, wherein the healthcare topic is a multimedia healthcare segment.
